(19) United States
(12) Patent Application Publication
(10) Pub. No.: US 2006/0089877 A1
(43) Pub. Date: Apr. 27, 2006

(54) System for paying vendor invoices

(76) Inventors: Joseph M. Graziano, Tualatin, OR (US); David G. Pease, Portland, OR (US); George A. Shand, West Linn, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/972,228

(22) Filed: Oct. 22, 2004

(51) Int. Cl. G06Q 30/00

(52) U.S. Cl. 705/14

(57) ABSTRACT

A system for using credit card accounts to pay vendor invoices.

### BACKGROUND OF THE INVENTION

The present invention relates to a system for using credit card accounts to pay vendor invoices.

The financial industry encourages consumers to use credit card accounts when purchasing goods or services at point of sale and other transactions. Credit card purchases benefit the financial industry in several ways. First, credit account balances generate interest revenue for lenders (e.g., banks) who provide credit under the account agreement associated with the credit card used. This interest revenue can be quite substantial. Second, and perhaps less obviously, for every credit card transaction, vendors are charged by the credit card institutions (Master Card, Visa, American Express, etc.) a fee—usually a percentage of the transaction amount—for the privilege of being paid by lenders offering their respective cards. This revenue to the aforementioned credit card institutions is also quite substantial.

Credit cards are used quite frequently in the consumer transaction market due to their convenience and, to a lesser extent are also used in the business transaction market. That is to say, a number of businesses have business credit card accounts that they use in point of sale transactions (hotels, restaurants, etc), again due to the convenience of using credit cards. However, for practical purposes, the use of business credit cards has been primarily limited to point of sale purchases from vendors that also do a substantial amount of consumer business. This is largely due to the percentage fee that the credit card institutions charge to vendors; whereas a hotel or a restaurant is already equipped with the infrastructure to charge payments to credit cards and uses a pricing structure that assumes the percentage fee to be received by the credit card institutions, many business vendors, such as electrical supply or other wholesalers, are not. Rather, such vendors typically will send monthly or other periodic invoices to their business customers for payment by check. This arrangement has been largely satisfactory due to the desire for businesses to limit the cost per unit purchased due to the large quantities of goods or services purchased i.e., the convenience of making a payment by credit card is not worth the additional percentage cost added to the transaction.

From the perspective of the credit card institutions and the banks who offer credit with their respective credit cards, this unfulfilled market is regrettable due to the sheer monetary vale of the transactions involved. What is desired, therefore, is an improved system for payment of vendor invoices by credit cards.

### BRIEF DESCRIPTION OF THE SEVERAL DRAWINGS

FIG. 1 shows a local computing device and an optional remote computing device capable of performing the disclosed system.

FIG. 2 shows a specific embodiment of the disclosed system performed by the local computing device of FIG. 1.

FIG. 2A shows an exemplary subsystem of the system of FIG. 1.

FIG. 3 shows a specific embodiment of the disclosed system performed by the local and remote computing devices of FIG. 1.

FIG. 4 shows a specific embodiment of the disclosed system used in conjunction with a stand-alone accounting program.

FIGS. 5-9 show respective screens in an exemplary computer program performing an embodiment of the disclosed system.

### DETAILED DESCRIPTION OF PREFERRED EMBODIMENTS

As stated previously, the primary disincentive for the use of credit card accounts for the payment of business vendor invoices is the percentage fee charged by the credit card institutions—a fee that is avoided when monthly payments are made by check. Because the purchase amounts involved are typically large, the percentage fee on the transaction will invariably be greater than the cost of a single check that covers the entire amount. If businesses were to make payments to their vendors by credit card, the resulting fees would be passed back to those businesses in the form of higher prices, driving up their cost of business.

Many existing credit cards have associated rewards programs for using the credit card. Examples of such cards are assorted airline mileage cards, automobile cards, cash back cards, and cards that offer a choice of reward selections, such as hotel reservations, car rentals, consumer goods such as music players, amusement park tickets, concert tickets, etc. These rewards, in theory, could offset the added costs of using business credit card accounts to pay vendor invoices rather than using a check. The existing problem with these rewards programs, however, is that the marginal reward value earned for every dollar spent with a given credit card account associated with a reward program (hereinafter referred to as a “rewards card”) is usually quite low, as it must be for the credit card institutions and banks offering their cards are to maintain their profits despite giving away these rewards. Thus even considering the fact that a business, by using a rewards card, might reap a monetary reward benefit to counter the added percentage cost on a monthly vendor transaction, the reward benefit expressed as a percentage of the transaction is still likely to be less than the percentage cost paid to the credit card institutions. Stated in other terms, payment of $100 to a vendor using a rewards card might yield a $3 benefit towards a reward such as an airline ticket, but the transaction will cost an additional $5 to be paid to the credit card institution.

Institutions using rewards cards, however, compete quite vigorously with each other. Typically this takes the form of double or triple rewards points for short intervals of time, for introductory periods, or for payments to favored businesses, etc. One mileage reward card, for example, might temporarily adjust the number of points needed to redeem an airline ticket during a time it seeks to attract new customers. Some rewards programs may decrease or increase the number of points needed to redeem a reward due to changes in the costs of providing the reward e.g., if the price of a Delta airline ticket rises, cards providing Delta flights might adjust the points needed to redeem an airline ticket upwards and vice versa. If a business had a number of rewards cards available to pay vendor invoices, and was meticulous enough to carefully monitor these temporary fluctuations in the incremental reward value achieved for each available card, and use the appropriate card, at the appropriate time, with the appropriate vendor, that business could game the system to make the use of the credit card worthwhile, i.e. could achieve an incremental reward benefit that exceeds the fees incurred due to the use of the credit cards.

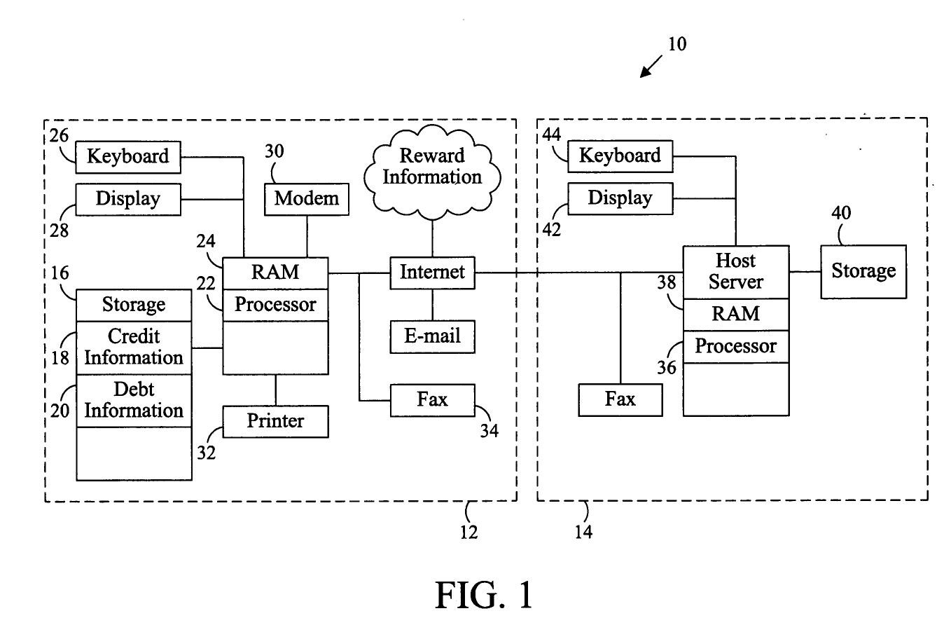

The problem, of course, is that most if not all businesses lack the time or resources to use rewards cards in a manner that achieves this result. Accordingly, FIG. 1 shows a system 10 comprising a local computing device 12 and an optional remote computing device 14. The local computing device 12 preferably includes storage 16 for storing credit information 18 for at least one credit card account and debt information 20 for at least one vendor. The local computing device 12 also preferably includes a processor 22, Random Access Memory (RAM) 24, input devices such as the keyboard 26 and/or a mouse, a visual display 28, a modem 30 or other device capable of communication with other systems through the Internet or otherwise, and a printer 32. Some embodiments of the disclosed system may employ a fax machine 34. If a system 10 includes a remote computing device 14, it may include its own processor 36, RAM 38, display 42, keyboard and/or mouse 44 and storage 40. Any remote computing device 14 provided with the system 10 preferably includes a connection to the Internet to facilitate communication between the local computing device 12 and the remote computing device 14.

Generally speaking, the disclosed system 10 is capable of retrieving selected credit information 18 and debt information 20 from storage 16 and allocating amounts due vendors among available rewards cards in a manner that maximizes the reward benefits obtained. The credit information 18 preferably includes a reward value associated with each credit card account stored in the storage 16 of the system 10, and these respective reward values are used by the system 10 to allocate debts among the stored credit card accounts. The system 10 uses a connection to the Internet to periodically update the credit information 18 to reflect the current reward values for the respective credit card accounts.

The term “reward value” should not be understood as requiring a numerical quantity or implying only a single value. For example, the disclosed system 10 may associate a reward value with each stored credit card account that is nothing more than a ranking among all stored accounts, such that vendor debts are first allocated to the highest (or lowest as the case may be) ranked card and sequentially to the next ranked card, etc. The reward value associated with each respective credit card accounts could be the actual incremental benefit, in dollars (or any other currency) received for each dollar charged on the account. Alternatively, the “reward value” could be a number of values or quantities. For example, where a given reward card gives double points for charges to a particular vendor stored in the storage 16, the “reward value” may comprise a number of indicators, values, and/or quantities, indicate respective vendors and an incremental reward benefit associated with each vendor.

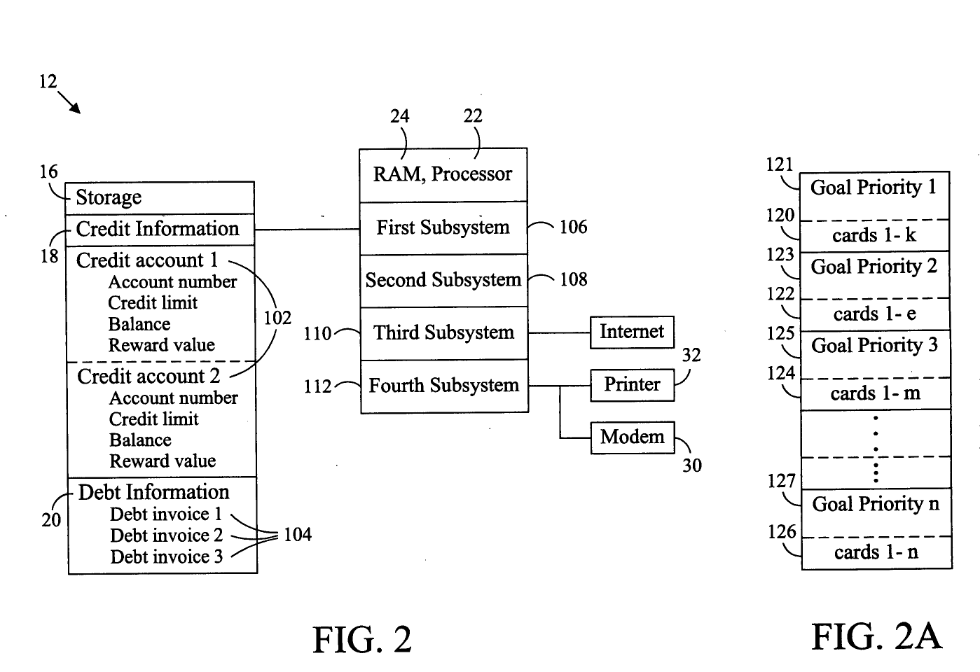

FIG. 2 shows an embodiment of the system 10 comprising the local computing device 12 having storage 16 storing credit information 18 associated with a plurality of credit card accounts 102 and debt information 20 associated with a plurality of debtor invoices 104. The credit information 18 for each credit card account 102 may include a respective account number, a respective credit limit, a respective account balance, a reward value as previously described that preferably indicates at least a reward benefit associated for using that particular credit card account, as well as any other credit information deemed pertinent. The debt information 20 may include a vendor identifier, an amount due, a date due, and/or any other information deemed pertinent.

The system 10 preferably includes a first subsystem 106 that retrieves the credit information 18 and debt information 20 from the storage 16 and allocates at least a portion of an amount due for one of the vendors to a selected credit card account based on the reward value associated with the selected credit card account. The system 10 may also include a second subsystem 108 capable of selectively updating the reward values associated with the respective credit card accounts 102 stored in storage 16.

In one embodiment of the disclosed system 10, the reward value associated with each credit card account may be fixed. For example, a relatively simple embodiment of the disclosed system 10 may use a reward value that is a ranking or value merely reflecting the incremental movement towards a reward for each dollar spent on the account. That is to say, if a credit card offers a reward of a round trip airline ticket upon the accumulation of a certain number “n” of points and “x” number of points are earned for each dollar charged to the card, a reward value might simply be the ratio of “x” divided by “n” which is the benefit gained toward a chosen reward for each dollar charged to the card.

The embodiment just described is particularly appropriate if a business is interested in a single reward type (e.g., airline tickets) and therefore includes credit information for only credit card accounts that offer airline miles. This embodiment might be preferred, for example, by a business or government agency whose employees often fly on business trips. By allocating vendor debts to selected credit card accounts in a manner that achieves free airline tickets as rapidly as possible, such a business or agency would achieve a substantial cost savings than if the debts were allocated randomly among several credit card accounts.

The aforementioned embodiment may not always be optimal, however. Some businesses might desire to collect more than one type reward or may merely be interested in achieving the most cost benefit among a number of types of rewards cards, and relatively indifferent towards the particular reward earned. Assume, for example, that a business has a plurality of rewards cards representative of more than one type reward (e.g. some airline rewards cards, some hotel rewards cards, or several cards that each permit points to be redeemed for a variety of types of rewards). In that instance, the reward value might reflect the incremental monetary reward benefit for each dollar charged to the account. For example, using the parameters “x”, and “n” as previously described, the reward value could be the dollar value “d” of the reward associated with the particular credit card account multiplied by the ratio of “x” divided by “n.” If a given credit card account has more than one reward being redeemable, each reward will have an associated dollar value, an associated number of points required to redeem that reward, and an associated number of points earned for each dollar charged on the card, and thus the reward value could be the highest product of“d” multiplied by “x” and divided by “n.” This particular embodiment might be appropriate for a sole proprietorship or family business who selects the types of rewards the owners are likely to use the most and seek to distribute their payments among their business credit cards in a manner that achieves the highest cost benefit.

Still other types of reward values may be appropriate. A given reward card may offer double or triple points if charges are made to a specific vendor. If so, the reward value will preferably include a value or identifier for each vendor account or for groups of vendor accounts so that the first subsystem may allocate amounts due to certain preferred vendors to that account. Similarly, some employers may offer employee benefits in the form of vacation packages where it is desirable to achieve rewards in groups or packages i.e., a round trip airline ticket, a hotel reservation, and a car rental. In that instance, the “reward value” associated with each credit card account could comprise two values, one that indicates the type of reward in the selected package, and a second that represents the incremental movement toward the reward for each dollar charged to the account, where the first subsystem allocates vendor debts among types of rewards cards in a manner that achieves rewards in the selected packages.

As should be evident, many types of reward values are compatible with the present system and will largely depend upon the individual desires of the users. For that reason, the system 10 may include a third subsystem 110 that permits a user to select one of a plurality of rewards goals. For example, the system 10 may offer the user a choice of reward goals, where each reward goal is associated with one of the aforementioned reward values. Thus a particular embodiment of the system 10 may permit a user to select a reward goal that either maximizes the incremental movement towards a preferred reward, maximizes the incremental benefit value of monthly charges, or achieves rewards in packages. Other options are easily envisioned. A user may be given a choice to equalize payments among all available credit cards as well as a choice maximize the float i.e. the time between charging an amount to the credit card and the due date for the next credit card installment.

FIG. 2A shows an exemplary third subsystem sufficiently flexible to permit a user to establish a customized reward goal. Many reward programs are associated with a number of credit cards. For example, the United Mileage Plus program may be associated with quite a few different credit cards, yet points earned for purchases made on several respective individual cards may be combined towards a reward of a round trip airline ticket. To take advantage of this feature, a user of the disclosed system may have a credit card set 120 comprising one or more individual cards 1-k each individual card associated with one reward type, e.g. United Mileage Plus or other airline mileage program. The user may also have additional credit card sets 122, 124, and 126 each of which also comprises one or more individual cards associated with one reward type. The third subsystem 110 may then permit the user to establish goal priorities 121, 123, 125, and 127 and assign reward values to each individual card to maximize the achievement of the selected reward goal.

As one example, assume that a particular user wishes to establish an employee benefit program in which vacation packages are to be accumulated comprising a round trip airline ticket, a hotel reservation, and a car rental. In that instance, goal priority 121 could be “airline tickets”, goal priority 123 could be “hotel reservations” and goal priority 125 could be “automobile rentals.” If the user has more than one credit card account associated with any one of the chosen rewards e.g., more than one Mileage Plus card, the rewards values for those cards may be ranked primarily by their goal priority and secondarily by the incremental benefit achieved for a dollar charged on the card. Thus in operation, vendor accounts are first charged to the credit card set associated with goal priority 121 until a respective reward benefit e.g., a round trip airline ticket, is achieved. Because the credit card set 120 may include more than one credit card, the rewards points of which are cumulative, the reward benefit associated with the goal priority 121 may be achieved more quickly for two reasons. First, each credit card in the credit card set 120 may be prioritized so that vendor debts are first allocated to the card that achieves the highest incremental benefit per dollar charged. Second, once the credit limit for the highest priority card in credit card set 120 is reached, vendor debts may be allocated to other cards in the credit card set 120 rather than a card that earns points to a different reward.

Once the reward associated with the goal priority 121 is achieved, vendor accounts are charged to the card or cards associated with the second priority goal until that reward benefit is achieved, and so forth until a vacation package is attained and the process may begin anew to achieve additional vacation packages.

The exemplary third subsystem shown in FIG. 2A may also be used to achieve a variety of other types of reward goals. For example, if a user simply wants to accumulate round trip airline tickets, each of the credit card sets 120, 122, 124, and 126 may pertain to a given airline mileage reward program, e.g. United, Delta, Northwest, etc. Alternatively, if the user wishes to maximize the monetary value of the rewards, credit card set 120 associated with the highest priority goal would be the credit card set offering the highest value reward per dollar charged and so forth.

The exemplary third subsystem shown in FIG. 2A may also be modified to accommodate vendors who only accept certain types of credit cards. Thus if a vendor only accepts American Express, and no credit card in the credit card set 120 is an American Express card, the debt for that vendor may be allocated to a credit card set that includes an American Express card. Furthermore, the exemplary third subsystem shown in FIG. 2A is illustrative only, and may be modified as desired or replaced with any other appropriate subsystem that permits a user to select or otherwise implement a desired reward goal.

The system 10 is preferably has a first subsystem 106 that is as flexible as possible. Thus the first subsystem 106 may permit a user to adjust any amount allocated to a particular credit card. While some embodiments of the first subsystem 106 may simply permit a single vendor invoice to be charged to a single credit card account, other embodiments may permit a monthly vendor invoice to be split among multiple credit card accounts. Preferably, the system 10 includes a first subsystem 106 that permits multiple vendor invoices to be charged to a single credit card in any given month.

The system 10 preferably includes a connection to the Internet to permit the second subsystem 108 to periodically update the reward values associated with the credit information for each of the plurality of credit card accounts stored in the storage 16. Typically, the second subsystem 108 will include a number of internet addresses at which current reward information may be available. Alternatively, there are a number of automated web searching tools available e.g., web crawlers that may easily collect the necessary data to update the reward information.

The system 10 may also include a fourth subsystem 112 capable of generating a credit card authorization with which a vendor invoice or a portion of a vendor invoice is charged to a particular credit card account. Typically, credit card authorizations are paper transactions to be submitted by the vendor. In that instance, the fourth subsystem 112 may use a printer to print a paper copy of an authorization to be sent to the vendor, or may simply send an authorization form by fax to the appropriate vendor. Alternatively, the fourth subsystem may generate an electronic authorization by which amounts due are charged to a credit card account by the system 10 without submission of a form to the vendor. In that instance, the business using the system 10 may have the vendor's identification number or other required information so that amounts due to a vendor are paid in a manner that is transparent to the vendor, such that the vendor need not be given any personal credit information, such as a credit card number or expiration date in order for a payment to be submitted. This option, is obviously more secure.

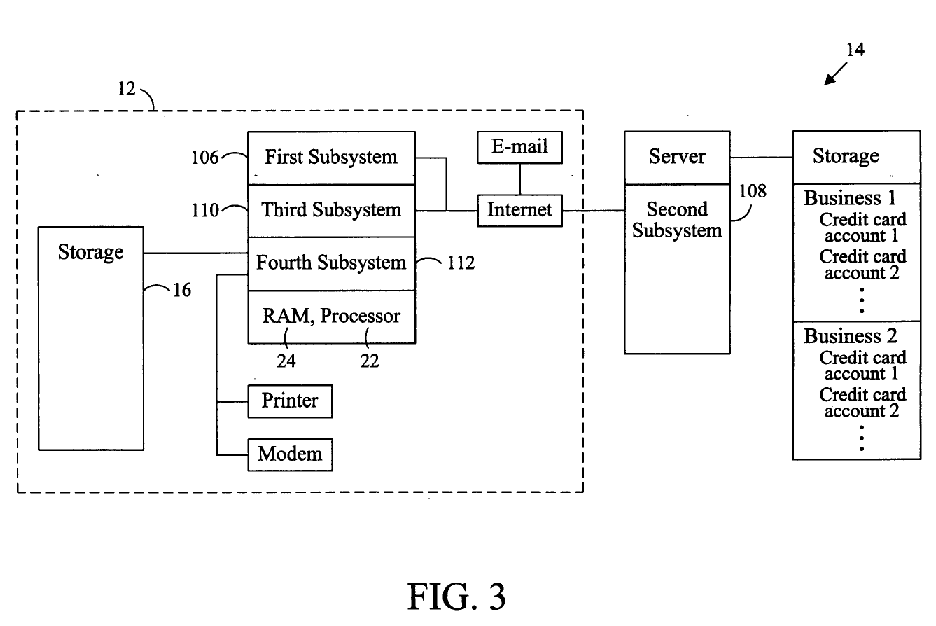

FIG. 2 shows a system 10 that is self-contained i.e., it is entirely embodied in the local computing device 12. It may be preferable to also include a remote computing device 14 as depicted in FIG. 3. In that instance, the local computing device 12 may include the storage 16 necessary to store the aforementioned credit information and debt information, and include the first subsystem 106 that allocates amounts due among selected credit card accounts, the third 110 subsystem that optionally permits a user to select a choice from a plurality of reward goals, and the fourth subsystem 112 that generates a credit authorization, either paper or electronic. The remote computing device may include the second subsystem 108 that selectively updates the reward values. In this embodiment, the remote computing device 14, which may be a remote server, includes storage that stores data pertaining to the businesses using the disclosed system 10, the credit card accounts used by each of those businesses, and the reward values associated with each of the credit card accounts used, where the reward values for a given credit card may be unique to a given business, as mentioned previously. The remote server periodically updates the stored reward information. If any given reward information changes, businesses whose system 10 uses that reward information or reward value are sent a notice or alert by e-mail or otherwise indicating that there are recent updates. When an affected business next uses the system 10, the alert is received and the user may selectively connect to the remote server to have the appropriate reward values updated prior to the time the first subsystem begins to allocate amounts due on vendor's invoices.

Existing automated accounting systems do not provide for automated payment of vendor invoices using credit cards. Typically, if a user elects to pay a vendor using a credit card, the user must first pay the debt using a credit card and afterwards manually enter the transaction into the accounting system, flagging the debt as being paid by credit card, and sometimes will be given the option of entering further details about the transaction, such as the credit card used, payment due date, etc., into a comment field. However, this comment field does not provide an effective means of searching, e.g., requesting that the accounting system display all vendor invoices paid with a given credit card.

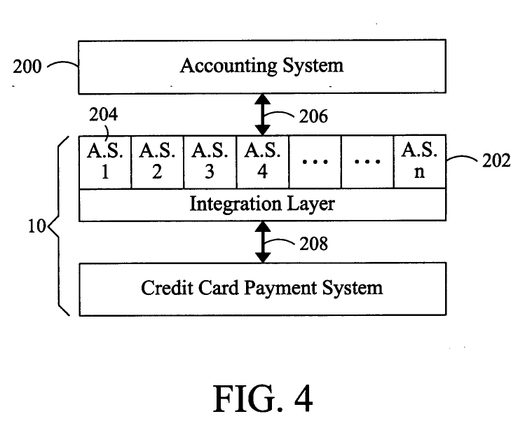

The disclosed system 10 conveniently permits the automated payment of vendor invoices with credit cards. Furthermore, the system 10 does so in a manner that permits credit card payments to be searched by any desired parameter. The system 10 may be used with an existing stand alone accounting system, such as one provided by Great Plains, Quickbooks, MA590, Timberline, or ACCPAC, etc. Referring to FIG. 4, the system 10 may include an integration layer 202 comprising one or more integration modules 204 that each permit the system 10 to communicate one of a number of available accounting systems. The disclosed system 10 preferably uses an appropriate integration module 204 to extract vendor data, including vendor names, amounts due, and dates due from the particular accounting system 200 used by the user. The disclosed system 10 then allocates the retrieved amounts due among the credit card accounts stored in the system 10 and preferably generates payment authorizations for payment of the retrieved debts using the stored credit card accounts. Preferably, this process is done in a manner that is transparent to the accounting system 200. The disclosed system 10 then flags the paid vendor debts in the accounting system as being paid.

The disclosed system 10 may preferably be searchable by any one or more desired parameters, such as credit card account, date due, date paid, reward benefit offered, etc. Furthermore, the disclosed system 10 is preferably independent from the accounting system 200 such that implementation of the disclosed system 10 requires no modification to the accounting system, and removal, detachment, or disassociation of the system 10 from the accounting system 200 leaves the accounting system 200 unaltered.

Preferably, the integration layer 202 includes a sufficient number of integration modules 204 to ensure compatibility with a variety of existing accounting systems. Furthermore, the disclosed system 10 may be periodically updated to add or update integration modules 204, as needed. The communication channels 206 and 208 between the integration layer 202 and the accounting system 200 and the credit card system 210 respectively may be APIs if desired.

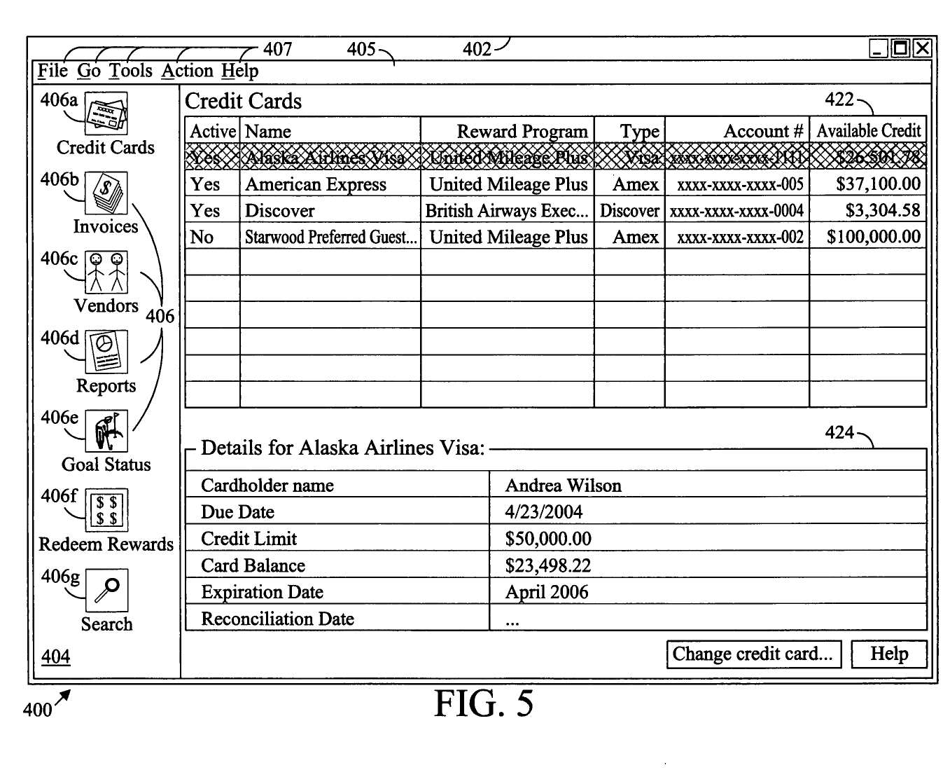

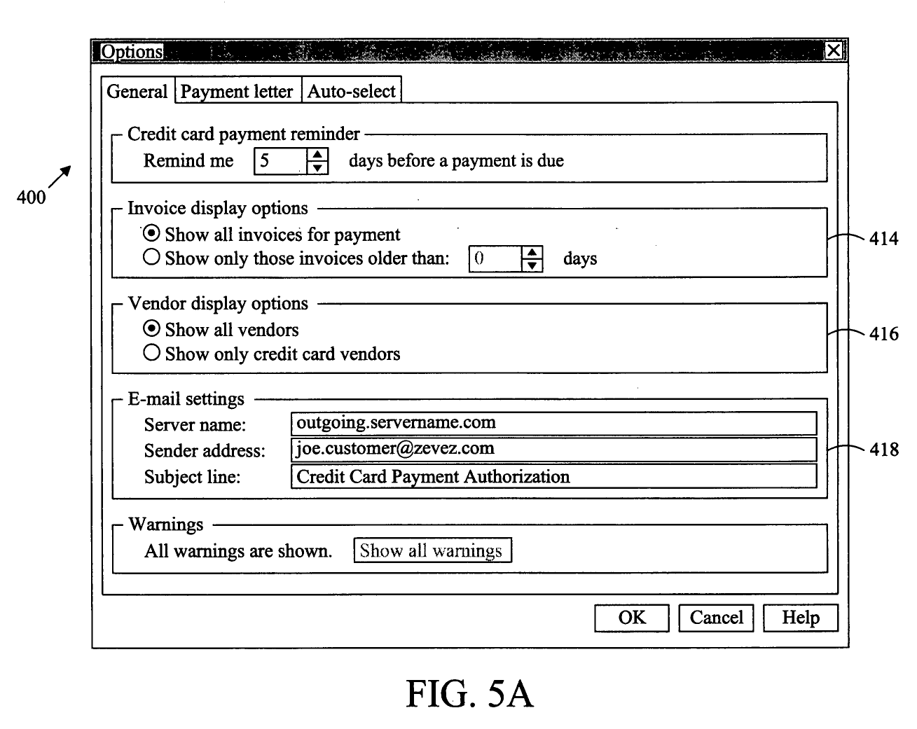

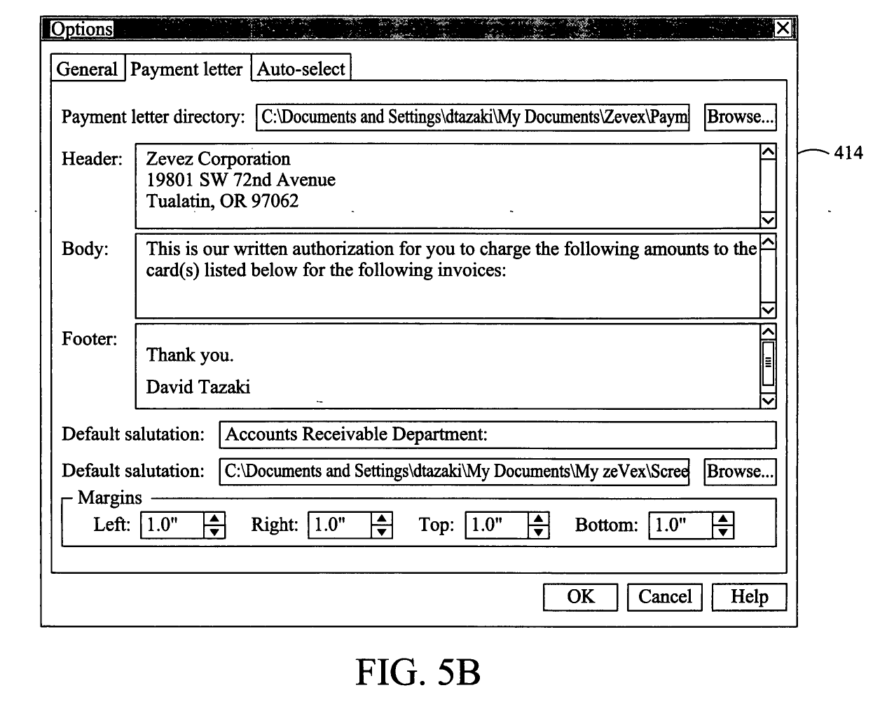

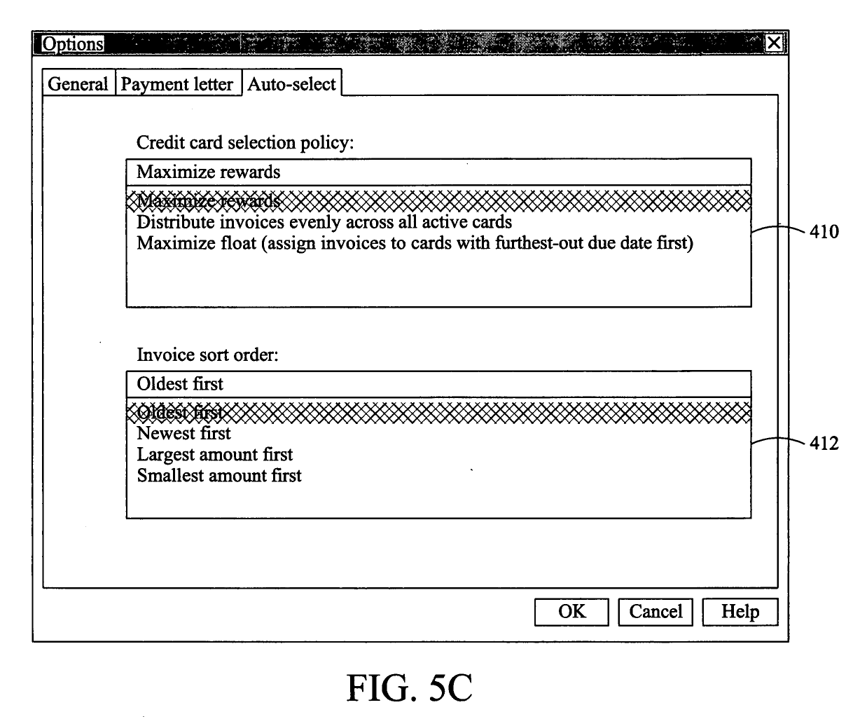

FIGS. 5-9 show one preferred computer program 400 that implements the disclosed system. The computer program 400 may present a user with a display 402 having fields 404 and 405 with icons 406 and/or menus 407 by which the user may navigate through the program 400. For example, the display 402 may include several display options, including “credit cards” 406a, “invoices” 406b, “vendors” 406c, “reports” 406d, “goal status” 406e, “redeem rewards” 406f, and “search” 406g, as well as icons permitting the selection of each of the display options. Each of the display options 406a-406g will be described in further detail below. Also, the field 405 may be a menu bar 4 providing additional navigation options by selecting the appropriate display options. The member 405 may be in the form of a standard Windows menu bar, having separate menus for “file,” “tools,” “help,” etc., or any other desired menu. Within each menu may be a submenu by which a user may take a selected action.

Upon initial start up, a user may preferably enter an options dialog through the tools menu item on the menu bar 407. Referring to FIGS. 5a through 5c, the options display may be used to set any one of a number of desired parameters. For example, a user may be able to choose from a number of rewards options within a dialog block 410. Such options may include, but are not limited to, “maximize rewards”, “distribute invoices evenly”, and “maximize float.” Each of these options has been previously described. A user may also be able to select the order in which invoices are sorted from the dialog block 412; invoice display options from dialog block 414, and vendor display options from dialog block 416. The options menu may also be used to set the e-mail address settings of the user through the dialog box 418, if the system is configured to send and receive e-mail. Furthermore, the options dialog may include a payment letter template 420 that is used by the system 10 to generate payment authorizations if the system 10 is configured to do so.

Referring to FIG. 5, the display 402 may be set to the credit card display option 406a by default. The display option 406a includes a window 422 that shows each of the credit card accounts to be used by the system 10 to pay vendor invoices. The window 422 may indicate, for each credit card account displayed, the name of the account, the status of the account (active or inactive), the reward program associated with the account, the type of credit card (Visa, Discover, etc.), the account number, and the amount of available credit. Each of the credit card accounts displayed in the window 422 may be highlighted by the user in order to display further information about that credit card account in a second display 424. This additional information may include the cardholder name, the due date of the next payment on the credit card, the credit limit on the credit card, the credit card balance, and the expiration date of the credit card.

The system 10 may store information pertaining to more credit card accounts than those displayed in the window 422. For example, a particular rewards goal selected by the user in the options dialog may cause the system 10 to choose selected credit card accounts to pay vendor invoices based on the respective reward values associated with the selected credit card accounts. The display option 406a may permit a user to override the system's selection of a given credit card account, using a button 426, thereby replacing a highlighted credit card account with a different credit card account.

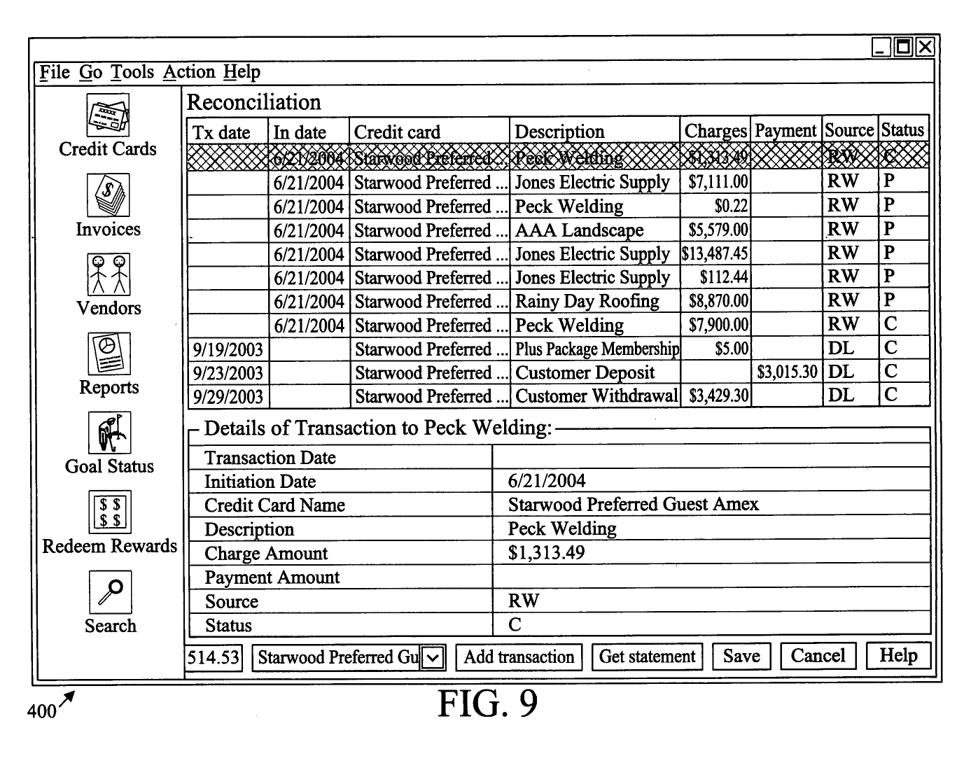

The system 10 may also permit a user to reconcile a credit card account from the display option 406a if the system 10 has an Internet connection. Referring to FIG. 9, for example, selection of a reconciliation button 428 may bring up a display 430 using information received from a credit card company over the Internet. The display 430 may include the transaction information posted to the account. Using the display 430, a user may add a recent transaction not yet posted so that the system 10 is using the correct amount of available credit for the selected credit card account. The display 30 may also be used to save the modified reconciliation data and/or print a reconciliation statement.

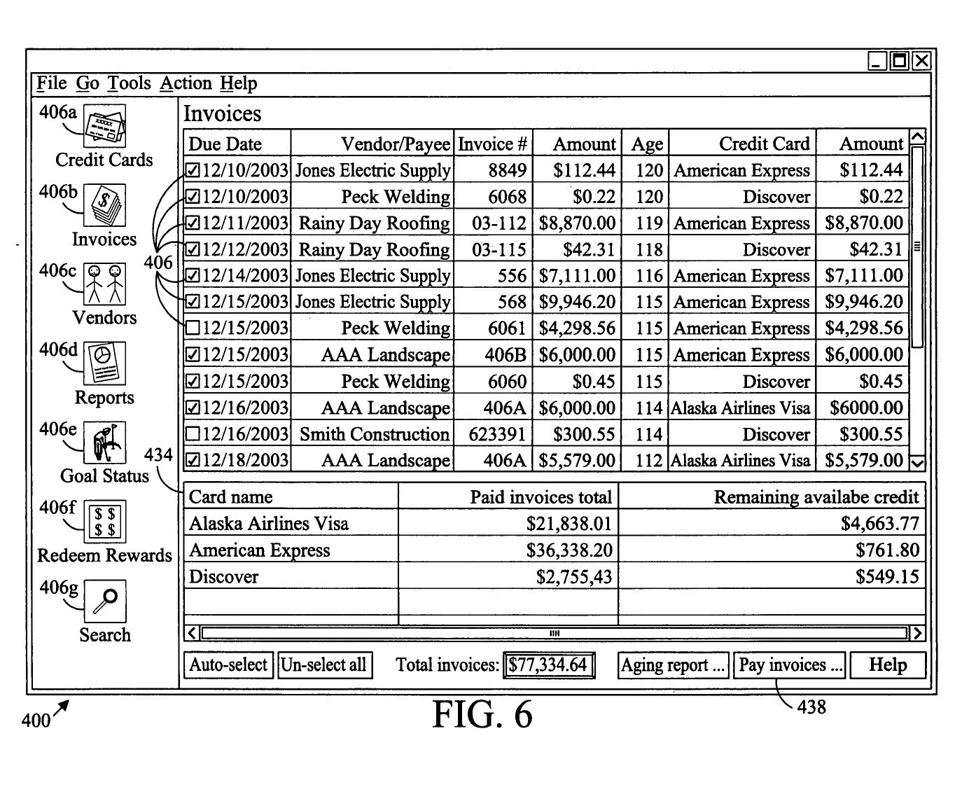

Referring to FIG. 6, the display option 406b may show a list of the vendor invoices to be paid by the system 10 using the credit card accounts displayed in display option 406a. The user may select or unselect individual invoices to be paid by checking selected boxes 436. Alternatively, the user may have the system automatically select invoices to be paid based upon the available credit of the credit card account shown in the display option 406a and the invoice sort order selected in the options dialog. The user may also obtain an aging report from the display option 406b. A window 434 may show the credit card accounts used by the system 10 to pay the invoices selected by the user, the amount charged to each of those accounts, and the remaining credit available on each of those credit card accounts. Once the user has selected all the invoices to be paid by the system 10, the user may select a button 438 that generates a payment authorization to the selected vendors. The display option 406b shown in FIG. 6 assumes the vendor information has been extracted from a stand alone-accounting program. Alternatively, the system 10 may be configured to add vendors from a database using a separate window, dialog or button.

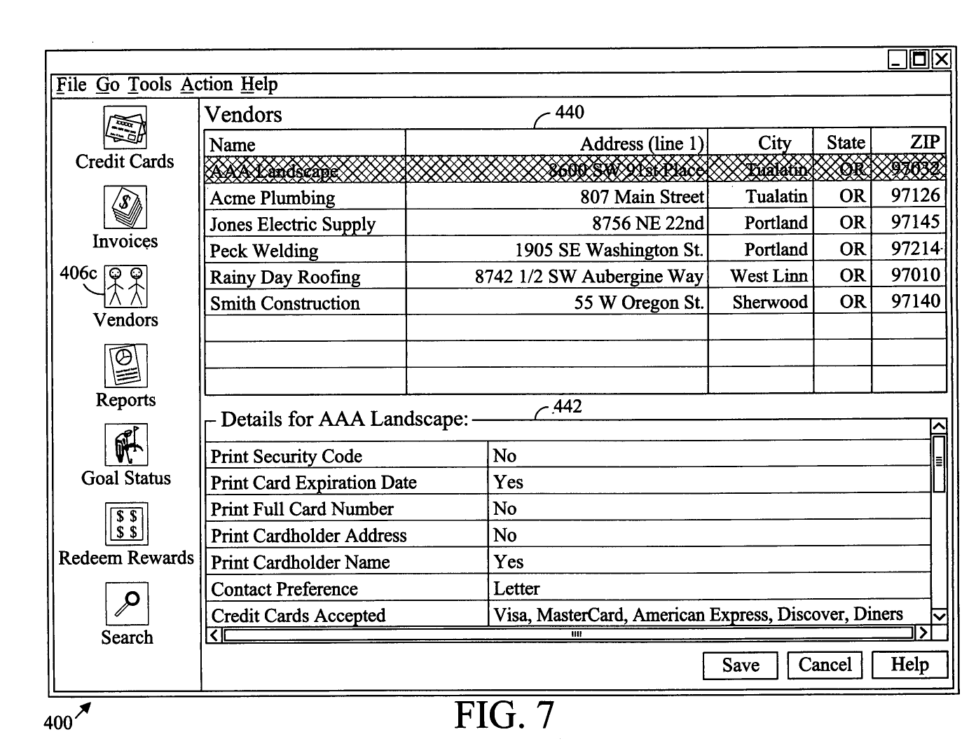

Referring to FIG. 7, display option 406c may show a list of vendors for which the system 10 stores debt information, i.e., invoices, in a window 440. A window 442 may be used to show additional information specific to a highlighted vendor including the credit cards accepted, how the vendor should be contacted etc.

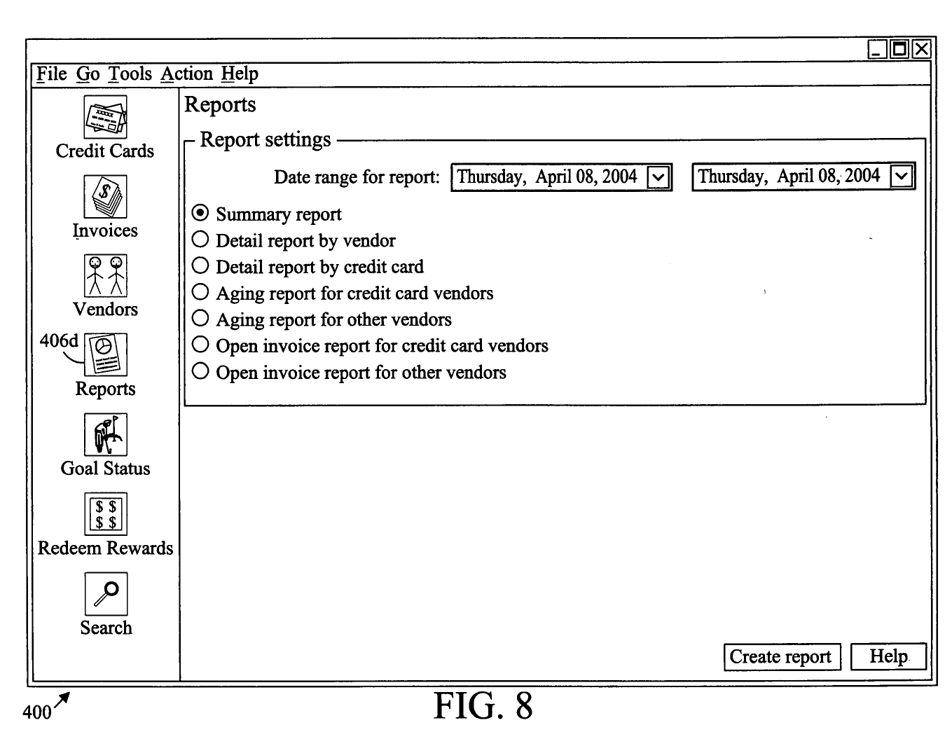

Referring to FIG. 8, a user may obtain any one of a number of reports using the display option 406d. The display option 406d may provide a choice of a summary report, a detail report by either vendor or credit card, aging reports or open invoice reports, or any other desired report. The display option 406d may also allow a user to select the date range for the chosen report.

The terms and expressions that have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims that follow.

1. A system comprising a computing device storing credit information for each of a plurality of credit card accounts and debt information for at least one vendor, said credit information including a respective credit limit, a respective account balance, and a reward value that indicates a reward benefit for using a respective one of said credit card accounts, said debt information including an amount due, said system capable of allocating at least a portion of an amount due for one of said vendors to a selected credit card account based on the reward value associated with said selected credit card account.

2. The system of claim 1 including a subsystem capable of selectively updating said at least one reward value.

3. The system of claim 2 including a local computer and a server and where said credit information and said debt information is stored on said local computer.

4. The system of claim 3 where said subsystem is stored on said server where said server and said local computer are accessible to one another over the Internet.

5. The system of claim 4 where said server is capable of using the Internet to store and update reward value information for a plurality of credit cards, said reward value information including the benefit or benefits offered and the amount that must be charged to achieve a respective benefit.

6. The system of claim 5 where said reward value information also includes the monetary value of the respective benefit or benefits offered.

7. The system of claim 3 where said subsystem is stored on said local computer and said subsystem selectively accesses said server to update at least one said reward value.

8. The system of claim 1 where said reward value reflects the incremental monetary value of the reward benefit obtained for each dollar charged on a respective credit card account.

9. The system of claim 1 where said reward value reflects the incremental movement toward a preferred reward for each dollar charged on a respective credit card account.

10. The system of claim 1 where said reward values establish an order in which said amounts due are allocated among said plurality of credit card accounts.

11. The system of claim 1 where said system allocates said portion of an amount due based on a comparison of the reward value associated with a said credit card account the reward value associated with at least one other said plurality of credit card accounts.

12. The system of claim 1 where said system allocates a remainder of an amount due for one of said vendors to a second credit card account based upon the reward value associated with said second credit card account.

13. The system of claim 1 where said system allocates at least a portion of an amount due for a second one of said vendors to said selected credit card account based upon the reward value associated with said selected credit card account.

14. The system of claim 1 including a system that selectively generates a credit authorization that charges to a selected credit card account the amounts due allocated to said selected credit card account by said first subsystem.

15. The system of claim 14 where said system generates a paper authorization.

16. The system of claim 1 where said third subsystem generates an electronic authorization.

17. The system of claim 1 including a server where said server is capable of registering users of said system, using the Internet to store and update reward value information for a plurality of credit cards, and sending an e-mail to a selected user notifying said user when any reward value associated with a credit card account stored by the user's system changes.

18. The system of claim 1 where a user may adjust the amounts due allocated to a said credit card account by said system.

19. The system of claim 1 where said reward value represents the float associated with a credit card account.

20. The system of claim 1 including a subsystem capable of generating a report indicating the rewards earned in a selected calendar year.

21. A system including a computing device storing credit information for each of a plurality of credit card accounts and debt information for at least one vendor, said credit information including a respective credit limit, a respective account balance, and a reward value that indicates a reward benefit for using a respective one of said credit card accounts, said debt information including an amount due, said system comprising:
(a) a first subsystem that receives from a user a selected reward goal out of a plurality of available reward goals; and
(b) a second subsystem that allocates at least a portion of an amount due for one of said vendors to a selected credit card account based on the selected reward goal and the reward value associated with said selected credit card account.

22. The system of claim 21 where one of said plurality of available goals is obtaining the most of a selected rewards package that associates a plurality of selected rewards to be achieved in equal numbers.

23. The system of claim 21 where said plurality of available reward goals includes at least one of:
(a) obtaining the most of a selected reward;
(b) equalizing the dollar amounts allocated among said plurality of credit card accounts;
(c) minimizing the present value of amounts paid to said at least one vendor;
(d) maximizing the dollar value of rewards earned; and
(e) obtaining the most of a selected rewards package.

24. The system of claim 21 where said second subsystem allocates a remainder of an amount due for one of said vendors to a second credit card account based upon the selected reward goal and the reward value associated with said second credit card account.

25. The system of claim 21 including a third subsystem that selectively generates a credit authorization that charges to a selected credit card account the amounts due allocated to said selected credit card account by said second subsystem.

26. The system of claim 25 where said third subsystem generates a paper authorization.

27. The system of claim 25 where said third subsystem generates an electronic authorization.

28. The system of claim 21 including a server where said server is capable of registering users of said system, using the Internet to store and update reward value information for a plurality of credit cards, and sending an e-mail to a selected user notifying said user when any reward value associated with a credit card account stored by the user's system changes.

29. The system of claim 21 where a user may adjust the amounts due allocated to a said credit card account by said first subsystem.

30. The system of claim 21 including a third subsystem capable of generating a report indicating the rewards earned in a selected calendar year.

31. In combination with a computing device storing credit information for each of a plurality of credit card accounts and debt information for at least one vendor, said credit information including a respective credit limit, a respective account balance, and a reward value that indicates a reward benefit for using a respective one of said credit card accounts, said debt information including an amount due, a method comprising:
(a) receiving a reward goal from a user;
(b) allocating at least a portion of an amount due for one of said vendors to a selected credit card account based on the reward value associated with said selected credit card account; and
(c) generating a credit authorization that charges said at least a portion of an amount due to said selected credit card account.

32. The method of claim 31 where said credit authorization is a paper authorization.

33. The method of claim 31 where said credit authorization is an electronic authorization.

34. The method of claim 31 where said reward value associated with each of said credit card accounts is selectively updatable.

35. The method of claim 34 including the steps of:
(a) using the Internet to periodically check the dollar amount that must be charged on a respective credit card account to achieve a respective benefit associated with said credit card account; and
(b) updating a respective reward value for a credit card account when said dollar amount for said credit card account changes.

36. The method of claim 35 where said steps (a), (b), and (c) are performed by a local computer and steps (d) and (e) are performed by a remote server.

37. The system of claim 31 where said reward value reflects the incremental monetary reward value benefit obtained for each dollar charged on a respective credit card account.

38. The system of claim 31 where said reward value reflects the incremental movement toward a preferred reward for each dollar charged on a respective credit card account.

39. The system of claim 31 where said reward values establish an order in which said amounts due are allocated among said plurality of credit card accounts.

40. A system including a computing device capable of storing credit information for each of a plurality of credit card accounts and debt information for at least one vendor, said credit information including a respective credit limit and a respective account balance, said debt information including an amount due, said system comprising:
(a) a first subsystem that allocates at least a portion of an amount due for a selected vendor to a selected credit card account; and
(b) a second subsystem capable of selectively generating an electronic credit authorization that charges to said selected credit card account the amounts due allocated to said selected credit card account by said first subsystem, said electronic credit authorization being transparent to the said selected vendor.

41. A system including a computing device capable of interacting with an accounting system on a computing device storing debt information for at least one vendor, said debt information including an amount due, said system comprising:
(a) a first subsystem capable of extracting a list of vendors in said accounting system and debt information pertaining to those vendors;
(b) a second subsystem capable of identifying vendors who accept credit cards from said list and allocating at least a portion of said debt information associated with at least one of said extracted vendors to a credit card account, and generating a credit card payment authorization for payment of said at least a portion of said debt information; and
(c) a third subsystem capable of adjusting said debt information in said accounting system to reflect the payment authorized by said second subsystem.

42. The system of claim 41 where said computing device stores credit information for each of a plurality of credit card accounts, said credit information including a respective credit limit and a respective account balance and said second subsystem selects a selective one of said plurality of credit card accounts to which said at least a portion of said debt is allocated.

43. The system of claim 42 where said credit information includes a respective reward value associated with each of said plurality of credit card accounts

44. The system of claim 43 where said second subsystem selects said selective one of said credit card accounts based upon the reward value associated with said account.

45. The system of claim 43 where said reward value is selectively updatable through a connection with the Internet.

46. The system of claim 43 where said reward value reflects the incremental monetary value of the reward benefit obtained for each dollar charged on a respective credit card account.

47. The system of claim 43 where said reward value reflects the incremental movement toward a preferred reward for each dollar charged on a respective credit card account.

48. The system of claim 43 where said second subsystem allocates a remainder of an amount due for said at least one of said extracted vendors to a second credit card account.

49. The system of claim 48 where said remainder of an amount due is allocated to said second credit card account based upon the reward value associated with said second credit card account.

50. The system of claim 41 where said authorization is an electronic authorization.
